(19) United States
(12) Patent Application Publication
(10) Pub. No.: US 2014/0336233 A1
(43) Pub. Date: Nov. 13, 2014

(54) USE OF TETRAMIC ACID DERIVATIVES FOR CONTROLLING PATHOGENS BY FOLIAR APPLICATION

(71) Applicants: Marie-Pascale Latorse, St. Romain De Popey (FR); Marie-Claire Grosjean-Cournoyer, Curis Au Mont D'or (FR)

(72) Inventors: Marie-Pascale Latorse, St. Romain De Popey (FR); Marie-Claire Grosjean-Cournoyer, Curis Au Mont D'or (FR)

(73) Assignee: Bayer Intellectual Property GmbH, Monheim (DE)

(21) Appl. No.: 14/237,074

(22) PCT Filed: Aug. 2, 2012
(86) PCT No.: PCT/EP2012/065145

§ 371 Date: Mar. 4, 2014

Related U.S. Application Data
(60) Provisional application No. 61/521,085, filed on Aug. 8, 2011.

(30) Foreign Application Priority Data
Aug. 5, 2011 (EP) 11176700.0

(51) Int. Cl. A01N 43/38; A01N 47/06

(52) U.S. Cl. CPC A01N 43/38; A01N 47/06
USPC 514/409

(57) ABSTRACT

Compounds of the formulae (I) and (II) for controlling pathogens by foliar application.

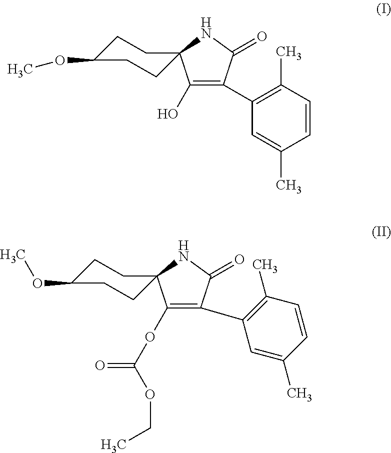

The present invention relates to the use of tetramic acid derivatives for controlling pathogens by foliar application.

Tetramic acid derivatives (WO 98/05638) and also their cis isomers (WO 04/007448) having insecticidal and/or acaricidal activity are known.

Also known is the use of tetramic acid derivatives against spider mites and insects after drenching, drip application or soil injection (WO 07/126691).

Moreover, a fungicidal action of biphenyl-substituted tetramic acid derivatives following foliar application has been disclosed in WO 03/059065.

The use of tetramic acid derivatives for controlling pathogens by drip or drenching application has also been disclosed (WO 09/083132).

Surprisingly, it has now been found that the compounds of the formulae (I) and (II)

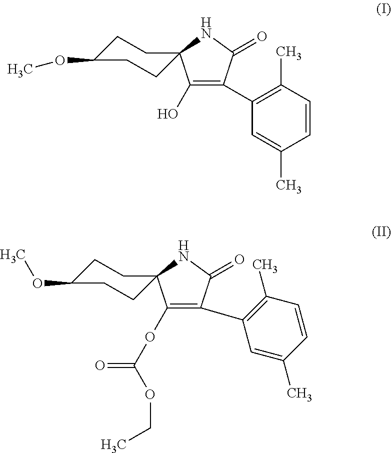

are likewise suitable for controlling pathogens by foliar application.

Emphasis is given to compounds of the formula (I).

Emphasis is also given to compounds of the formula (II).

Accordingly, the present invention relates to the use of tetramic acid derivatives for controlling pathogens by foliar application. The present invention furthermore relates to these application forms on natural substrates (soil) or artificial substrates (for example rock wool, glass wool, quartz sand, gravel, expanded clay, vermiculite), outdoors and field conditions or in closed systems (for example greenhouses or under cloches) and in annual (for example vegetables, spices, ornamental plants, broad acre crops) crops as well as in perennial crops (for example pome and stone fruit, nut trees, tropical crops including avocado, mango, banana, pineapple, cocoa, coffee trees, palm trees) and nurseries.

The crops to be protected will be described in greater detail and specified herein below. Thus, as regards the use, vegetables are understood as meaning for example fruiting vegetables, and inflorescences as vegetables, for example bell peppers, chilies, tomatoes, aubergines, cucumbers, pumpkins, courgettes, broad beans, runner beans, dwarf beans, peas, artichokes, corn;

but also leafy vegetables, for example head-forming lettuce, chicory, endives, various types of cress, of rocket, lamb's lettuce, iceberg lettuce, leeks, spinach, Swiss chard;

furthermore tuber vegetables, root vegetables and stem vegetables, for example potatoes, celeriac/celery, beetroot, carrots, radish, horseradish, scorzonera, asparagus, beet for human consumption, palm hearts, bamboo shoots, furthermore bulb vegetables, for example onions, leeks, Florence fennel, garlic;

furthermore Brassica vegetables such as cauliflower, broccoli, kohlrabi, cabbage, red cabbage, white cabbage, curly kale, Savoy cabbage, Brussels sprouts, Chinese cabbage.

As regards the use, ornamentals are understood as meaning annual and perennial plants, for example cut flowers such as, for example, roses, carnations, gerbera, lilies, marguerites, chrysanthemums, tulips, narcissi, anemones, poppies, amaryllis, dahlias, rhododendron, azaleas, hibiscus,

but also for example bedding plants, pot plants and perennials such as, for example, roses, Tagetes, violas, geraniums, fuchsias, hibiscus, chrysanthemums, busy lizzies, cyclamen, African violet, sunflowers, begonias.

As regards the use, conifers are understood as meaning for example forest trees such as for example fir, true cedars, white-cedar, larch, pine, spruce, yew, Douglas fir;

but also for example young tree nurseries, such as for example Douglas fir, Fraser fir, red pine.

As regards the use, perennial crops are understood among others: pome and stone fruit, vine, tree nuts, tropical and sub-tropical fruit, mango, avocado, litchi, kaki, kiwi, papaya, pomegranate, banana, pineapple, cocoa, coffee, tea, palm trees, berries and small fruit.

As regards the use, spices are understood as meaning annual and perennial plants such as, for example, aniseed, chili pepper, paprika, pepper, vanilla, marjoram, thyme, cloves, juniper berries, cinnamon, tarragon, coriander, saffron, ginger.

As regards the use, broad acre crops are understood cotton, soybean, maize and other cereals for example wheat, barley, and oat.

Fungicides are employed in crop protection for controlling Plasmodiophoromycetes, Oomycetes, Chytridiomycetes, Zygomycetes, Ascomycetes, Basidiomycetes and Deuteromycetes.

Bactericides can be employed in crop protection for controlling Pseudomonadaceae, Rhizobiaceae, Enterobacteriaceae, Corynebacteriaceae and Streptomycetaceae.

Some pathogens causing fungal and bacterial diseases which come under the generic names listed above may be mentioned as examples, but not by way of limitation:

diseases caused by powdery mildew pathogens, such as, for example,

Blumeria species, such as, for example, Blumeria graminis;

Leveillula species, such as, for example, Leveillula taurica;

Oidium species, such as, for example, Oidium lycopersicum;

Podosphaera species, such as, for example, Podosphaera leucotricha;

Sphaerotheca species, such as, for example, Sphaerotheca fuliginea;

Uncinula species, such as, for example, Uncinula necator;

diseases caused by rust disease pathogens, such as, for example,

Gymnosporangium species, such as, for example, Gymnosporangium sabinae:

Hemileia species, such as, for example, Hemileia vastatrix;

Phakopsora species, such as, for example, Phakopsora pachyrhizi and Phakopsora meibomiae;

Puccinia species, such as, for example, Puccinia recondita;

Uromyces species, such as, for example, Uromyces appendiculatus;

diseases caused by pathogens from the group of the Oomycetes, such as, for example,

Bremia species, such as, for example, Bremia lactucae;

Peronospora species, such as, for example, Peronospora pisi, Peronospora parasitica or P. brassicae;

Phytophthora species, such as, for example, Phytophthora infestans, Phytophthora cinnamomi, Phytophthora cryptogea, Phytophthora megasperma; P. palmivora, P. megakarya, P. capsici, P. citrophthora, P. nicotianae, P. Tropicalis;

Plasmopara species, such as, for example, Plasmopara viticola;

Pseudoperonospora species, such as, for example, Pseudoperonospora humuli or

Pseudoperonospora cubensis;

Pythium species, such as, for example, Pythium ultimum;

leaf blotch diseases and leaf wilt diseases caused, for example, by

Alternaria species, such as, for example, Alternaria solani;

Cercospora species, such as, for example, Cercospora beticola;

Cladosporium species, such as, for example, Cladosporium cucumerinum;

Cochliobolus species, such as, for example, Cochliobolus sativus

(conidia form: Drechslera, syn: Helminthosporium);

Colletotrichum species, such as, for example, Colletotrichum lindemuthanium;

Cycloconium species, such as, for example, Cycloconium oleaginum;

Diaporthe species, such as, for example, Diaporthe citri;

Elsinoe species, such as, for example, Elsinoe fawcettii;

Gloeosporium species, such as, for example, Gloeosporium laeticolor;

Glomerella species, such as, for example, Glomerella cingulata;

Guignardia species, such as, for example, Guignardia bidwelli;

Leptosphaeria species, such as, for example, Leptosphaeria maculans;

Magnaporthe species, such as, for example, Magnaporthe grisea;

Mycosphaerella species, such as, for example, Mycosphaerella graminicola, Mycosphaerella musicola and Mycosphaerella fijiensis;

Phaeosphaeria species, such as, for example, Phaeosphaeria nodorum;

Pyrenophora species, such as, for example, Pyrenophora teres;

Ramularia species, such as, for example, Ramularia collo-cygni;

Rhynchosporium species, such as, for example, Rhynchosporium secalis;

Septoria species, such as, for example, Septoria apii;

Typhula species, such as, for example, Typhula incarnata;

Venturia species, such as, for example, Venturia inaequalis;

root and stem diseases caused, for example, by

Corticium species, such as, for example, Corticium graminearum;

Fusarium species, such as, for example, Fusarium oxysporum;

Gaeumannomyces species, such as, for example, Gaeumannomyces graminis;

Rhizoctonia species, such as, for example, Rhizoctonia solani;

Tapesia species, such as, for example, Tapesia acuformis;

Thielaviopsis species, such as, for example, Thielaviopsis basicola;

ear and panicle diseases (including corn cobs) caused, for example, by

Alternaria species, such as, for example, Alternaria spp.;

Aspergillus species, such as, for example, Aspergillus flavus;

Cladosporium species, such as, for example, Cladosporium cladosporioides;

Claviceps species, such as, for example, Claviceps purpurea;

Fusarium species, such as, for example, Fusarium culmorum;

Gibberella species, such as, for example, Gibberella zeae;

Monographella species, such as, for example, Monographella nivalis;

diseases caused by smut fungi, such as, for example,

Sphacelotheca species, such as, for example, Sphacelotheca reiliana;

Tilletia species, such as, for example, Tilletia caries;

Urocystis species, such as, for example, Urocystis occulta;

Ustilago species, such as, for example, Ustilago nuda;

fruit rot caused, for example, by

Aspergillus species, such as, for example, Aspergillus flavus;

Botrytis species, such as, for example, Botrytis cinerea;

Penicillium species, such as, for example, Penicillium expansum and Penicillium purpurogenum;

Sclerotinia species, such as, for example, Sclerotinia sclerotiorum;

Verticilium species, such as, for example, Verticilium alboatrum;

seed- and soil-borne rot and wilt diseases, and also diseases of seedlings, caused, for example, by

Alternaria species, such as, for example, Alternaria brassicicola;

Aphanomyces species, such as, for example, Aphanomyces euteiches;

Ascochyta species, such as, for example, Ascochyta lentis;

Aspergillus species, such as, for example, Aspergillus flavus;

Cladosporium species, such as, for example, Cladosporium herbarum;

Cochliobolus species, such as, for example, Cochliobolus sativus;

(conidia form: Drechslera, Bipolaris Syn: Helminthosporium);

Colletotrichum species, such as, for example, Colletotrichum coccodes;

Fusarium species, such as, for example, Fusarium culmorum;

Gibberella species, such as, for example, Gibberella zeae;

Macrophomina species, such as, for example, Macrophomina phaseolina;

Monographella species, such as, for example, Monographella nivalis;

Penicillium species, such as, for example, Penicillium expansum;

Phoma species, such as, for example, Phoma lingam;

Phomopsis species, such as, for example, Phomopsis sojae;

Phytophthora species, such as, for example, Phytophthora cactorum;

Pyrenophora species, such as, for example, Pyrenophora graminea;

Pyricularia species, such as, for example, Pyricularia oryzae;

Pythium species, such as, for example, Pythium ultimum;

Rhizoctonia species, such as, for example, Rhizoctonia solani;

Rhizopus species, such as, for example, Rhizopus oryzae

Sclerotium species, such as, for example, Sclerotium rolfsii;

Septoria species, such as, for example, Septoria nodorum;

Typhula species, such as, for example, Typhula incarnata;

Verticillium species, such as, for example, Verticillium dahliae

cancerous diseases, galls and witches' broom caused, for example, by

Nectria species, such as, for example, Nectria galligena;

wilt diseases caused, for example, by

Monilinia species, such as, for example, Monilinia laxa;

deformations of leaves, flowers and fruits caused, for example, by

Taphrina species, such as, for example, Taphrina deformans;

degenerative diseases of woody plants caused, for example, by

Esca species, such as, for example, Phaeomoniella chlamydospora and Phaeoacremonium aleophilum and Fomitiporia mediterranea;

diseases of flowers and seeds caused, for example, by

Botrytis species, such as, for example, Botrytis cinerea;

diseases of plant tubers caused, for example, by

Rhizoctonia species, such as, for example, Rhizoctonia solani;

Helminthosporium species, such as, for example, Helminthosporium solani;

diseases caused by bacterial pathogens, such as, for example,

Xanthomonas species, such as, for example, Xanthomonas campestris pv. oryzae;

Pseudomonas species, such as, for example, Pseudomonas syringae pv. lachrymans;

Erwinia species, such as, for example, Erwinia amylovora.

Emphasis is given to the control of pathogens from the group of Oomycetes.

The active compounds can be converted into the customary formulations, such as solutions, emulsions, wettable powders, water- and oil-based suspensions, powders, dusts, pastes, soluble powders, soluble granules, granules for broadcasting, suspoemulsion concentrates, natural compounds impregnated with active compound, synthetic substances impregnated with active compound, fertilizers and also microencapsulations in polymeric substances.

These formulations are produced in a known manner, for example by mixing the active compounds with extenders, that is, liquid solvents, and/or solid carriers, optionally with the use of surfactants, that is to say emulsifiers and/or dispersants, and/or foam-formers. The formulations are prepared either in suitable facilities or else before or during application.

Suitable for use as auxiliaries are substances which are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulphoxide, and also water.

According to the invention, a carrier is a natural or synthetic, organic or inorganic substance which may be solid or liquid and with which the active compounds are mixed or bonded for better applicability, in particular for application to plants or plant parts. The solid or liquid carrier is generally inert and should be suitable for use in agriculture.

Suitable solid carriers are:

for example ammonium salts and ground natural minerals such as kaolins, clays, talc, chalk, quartz, attapulgite, montmorillonite or diatomaceous earth, and ground synthetic materials such as highly-disperse silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Furthermore, suitable oligo- or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and their adducts with formaldehyde.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations.

It is possible to use colourants such as inorganic pigments, for example iron oxide, titanium oxide and Prussian Blue, and organic colourants such as alizarin colourants, azo colourants and metal phthalocyanine colourants, and trace nutrients such as salts of iron, manganese, boron, copper, cobalt, molybdenum and zinc.

Other possible additives are perfumes, mineral or vegetable, optionally modified oils, waxes and nutrients (including trace nutrients), such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present.

The formulations generally comprise between 0.01 and 98% by weight of active compound, preferably between 0.5 and 90%.

In a preferred embodiment of the invention, to boost the activity, a penetrant is additionally added to the crop protection compositions. Suitable penetrants also include, for example, substances which promote the availability of the compounds of the formula (I) or (II) in the spray coating. These include, for example, mineral or vegetable oils. Suitable oils are all mineral or vegetable—optionally modified—oils which are usually used in agrochemical compositions. Mention may be made, by way of example of, sunflower oil, rapeseed oil, olive oil, castor oil, colza oil, maize seed oil, cotton seed oil and soya bean oil, or the esters of said oils. Preference is given to rapeseed oil, sunflower oil and their methyl and ethyl esters, in particular to rapeseed oil methyl esters.

The concentration of penetrant in the compositions according to the invention can be varied within a wide range. In the case of a formulated crop protection composition it is generally from 1 to 95% by weight, preferably from 1 to 55% by weight, particularly preferably 15-40% by weight. In the ready-to-use compositions (spray liquors), the concentration is generally between 0.1 and 10 g/l, preferably between 0.5 and 5 g/l.

The active compounds according to the invention can furthermore be present in their commercially available formulations and in the use forms, prepared from these formulations, as a mixture with synergists. Synergists are compounds which increase the action of the active compounds, without it being necessary for the synergist added to be active itself.

The active compounds according to the invention can furthermore be present in their commercially available formulations and in the use forms, prepared from these formulations, as mixtures with inhibitors which reduce degradation of the active compound after use in the environment of the plant, on the surface of parts of plants or in plant tissues.

The active compound content of the use forms prepared from the commercially available formulations can vary within wide limits. The active compound concentration of the use forms can be from 0.00000001 to 95% by weight of active compound, preferably between 0.00001 and 1% by weight.

Application occurs in a customary manner, suitable for the use forms.

All plants and plant parts can be treated in accordance with the invention. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Examples which may be mentioned are the important crop plants, such as cereals (wheat, rice), maize, soya beans, potatoes, sugar beet, tomatoes, peas and other vegetable species, cotton, tobacco, oilseed rape and also fruit plants (with the fruits apples, pears, citrus fruits and grapes). Plant parts are to be understood as meaning all above-ground and below-ground parts and organs of plants, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

Treatment according to the invention of the plants and plant parts with the active compounds is carried out directly or by allowing them to act on the surroundings, environment or storage space by the customary treatment methods, for example by immersion, spraying, evaporation, fogging, scattering, painting on, injecting and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering, if appropriate in combination with conventional methods (Genetically Modified Organisms), and parts thereof are treated. The terms “parts” or “parts of plants” or “plant parts” have been explained above.

Particularly preferably, plants of the plant cultivars which are in each case commercially available or in use are treated according to the invention. Plant cultivars are to be understood as meaning plants having new properties (“traits”) and which have been obtained by conventional breeding, by mutagenesis or by recombinant DNA techniques. They can be cultivars, biotypes or genotypes.

Depending on the plant species or plant cultivars, their location and growth conditions (soils, climate, vegetation period, nutrition), the treatment according to the invention may also result in superadditive (“synergistic”) effects. Thus possible are, for example, reduced application rates and/or a widening of the activity spectrum and/or an increase of the activity of the compounds and compositions usable according to the invention, better plant growth, increased tolerance to high or low temperatures, increased tolerance to drought or to water or soil salt content, increased flowering, easier harvesting, accelerated maturation, higher harvest yields, higher quality and/or higher nutritional value of the harvested products, increased storability and/or processability of the harvested products, which exceed the effects normally to be expected.

The preferred transgenic plants or plant cultivars (i.e. those obtained by genetic engineering) which are to be treated according to the invention include all plants which, in the genetic modification, received genetic material which imparts particularly advantageous useful properties (“traits”) to these plants.

Examples of such properties are better plant growth, increased tolerance to high or low temperatures, increased tolerance to drought or to water or soil salt content, increased flowering, easier harvesting, accelerated maturation, higher harvest yields, higher quality and/or a higher nutritional value of the harvested products, better storability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, sugar beet, tomatoes, peas and other types of vegetable, cotton, tobacco, oilseed rape and also fruit plants (with the fruits apples, pears, citrus fruits and grapes), with particular emphasis being given to maize, soya beans, potatoes, cotton, tobacco and oilseed rape. Traits that are emphasized in particular are increased defence of the plants against insects, arachnids, nematodes and slugs and snails by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are also particularly emphasized are the increased defence of the plants against fungi, bacteria and viruses by systemic acquired resistance (SAR), systemin, phytoalexins, elicitors and also resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinothricin (for example the “PAT” gene). The genes which impart the desired traits in question can also be present in combinations with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance against glyphosate, for example maize, cotton, soya beans), Liberty Link® (tolerance against phosphinothricin, for example oilseed rape), IMI® (tolerance against imidazolinones) and STS® (tolerance against sulphonylurea, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plants will be developed and/or marketed in the future.

The invention is illustrated by the examples below. However, the invention is not limited to the examples.

### EXAMPLE 1

### Efficacy against Phytophthora infestans Responsible for Potato and Tomato Late Blight

The treatment is done by spray application in a spray cabinet at 250 L/ha at the respective doses described in the tables. Upper sides of the leaves of six potato plants (variety Bintje, 4-5 weeks old) or six tomato plants (variety Rentita, 4-5 weeks old) are sprayed thanks to one agronomic nozzle. The plants are placed in a climatic chamber at 16° C.

24 hours after treatment, the plants are contaminated by spraying them with an aqueous suspension of Phytophthora infestans sporangia (40 000 sporangia per ml).

The plants are then placed in a climatic chamber at 16° C. day and night with saturate humidity until the notation.

Notation is carried out 5 days after the contamination and consists in evaluating the percentage of foliar surface showing symptoms of sporulation, in comparison with the untreated control but also contamined (UTC).

The efficacy of the treatment is calculated with the Abbott formula:

Efficacy=((surface with symptoms of the untreated−surface with symptoms of the treated)/surface with symptoms of the untreated)×100

Spirotetramat (Movento®) is tested in two independant trials from 0.01 g/ha to 1000 g.a.i. /ha in comparison with mancozeb (Dithane Neotech) and fluopicolide +propamocarb (Infinito) with regard to potatoe late blight.

Trial 1: In Vivo Test Against Potato Late Blight

| | | | Dose | | Corresponding |
|---|---|---|---|---|---|
| Active | | | product | | dose active |
| Ingredient | Formulation | | tested/ha | | g a.i./ha |
| spirotetramat | 100 | g/L SC | | | 1000-100-10- |
| (Movento ®) | | | | | 1-0.1-0.01 |
| Fluopicolide + | 62.5 + 625 | g/L SC | 1.6 | L | 100 + 1000 |
| propamocarb | | | | | |
| (Infinito ®) | | | | | |
| mancozebe | 750 | g/kg WG | 2 | kg | 1500 |
| (Dithane | | | | | |
| Neotec ®) | | | | | |

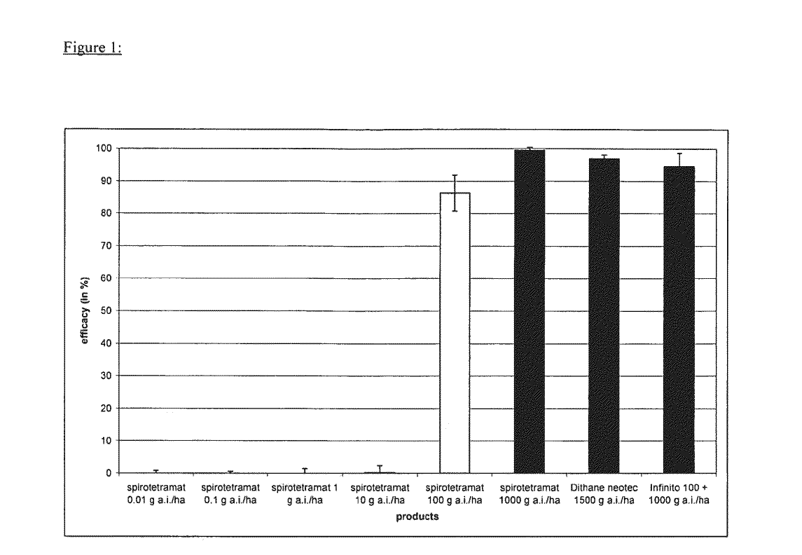

See FIG. 1 for: Efficacy of spirotetramat against P.infestans on potato in preventive 24 hour conditions.

The untreated controls show 99% of contamination.

The references Dithane Neotec and Infinito® show an efficacy on P. infestans with 97% and 95% of efficacy.

Spirotetramat shows 86% and 99% of efficacy respectively at 100 and 1000 g a.i./ha.

Trial 2: In Vivo Test Against Potato Late Blight

| | | | Dose | | Corresponding |
|---|---|---|---|---|---|
| Active | | | product | | dose active |
| Ingredient | Formulation | | tested/ha | | g a.i./ha |
| spirotetramat | 100 | g/L SC | | | 200-150-100- |
| (Movento ®) | | | | | 75-50-25 |
| fluopicolide + | 62.5 + 625 | g/L SC | 1.6 | L | 100 + 1000 |
| propamocarb | | | | | |
| (Infinito ®) | | | | | |
| mancozebe | 750 | g/kg WG | 2 | kg | 1500 |
| (Dithane | | | | | |
| Neotec ®) | | | | | |

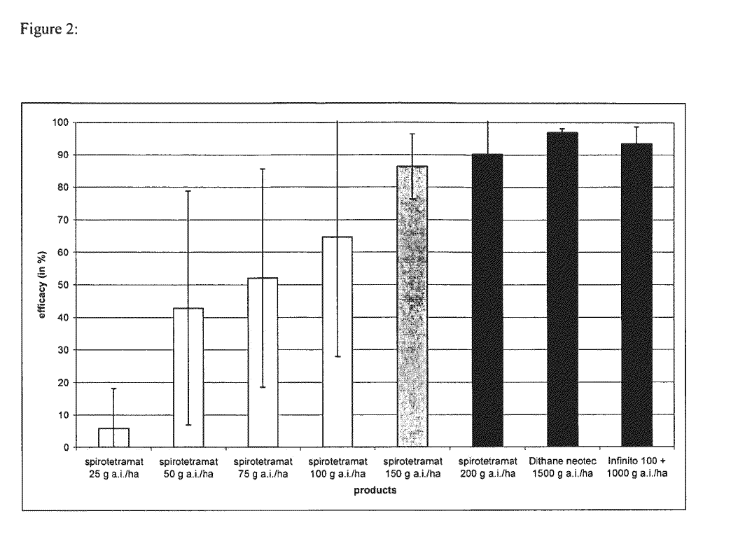

See FIG. 2 for: Efficacy of spirotetramat against P. infestans on potato in preventive 24 hour conditions.

The untreated controls show 99% of contamination.

The references Dithane Neotec® and Infinito® show an efficacy on P. infestans with 97% and 93% of efficacy.

The efficacy of spirotetramat is shown in FIG. 2 with a nice dose effect and efficacy equivalent to the best standard around 150 g a.i./ha under high disease pressure.

Trial 3: In Vivo Test Against Tomato Late Blight

The efficacy of spirotetramat is also tested against Phytophthora infestans on tomato at 100 g/ha and 200 g.a.i./ha in comparison with mancozeb (Dithane Neotech) and Ranman®.

| | | | Dose | Corresponding |
|---|---|---|---|---|
| Active | | | product | dose active |
| Ingredient | Formulation | | tested/ha | g a.i./ha |
| Spirotetramat | 100 | g/L SC | s | 200-100 |
| (Movento ®) | | | | |
| Cyazofamid | 400 | g/L SC | 0.2 (A) + | 80 |
| (A) + adj | | | 0.15 (B) L/ha | |
| (B) (Ranman ®) | | | | |
| mancozebe | 750 | g/kg WG | 2 kg | 1500 |
| (Dithane | | | | |
| Neotec ®) | | | | |

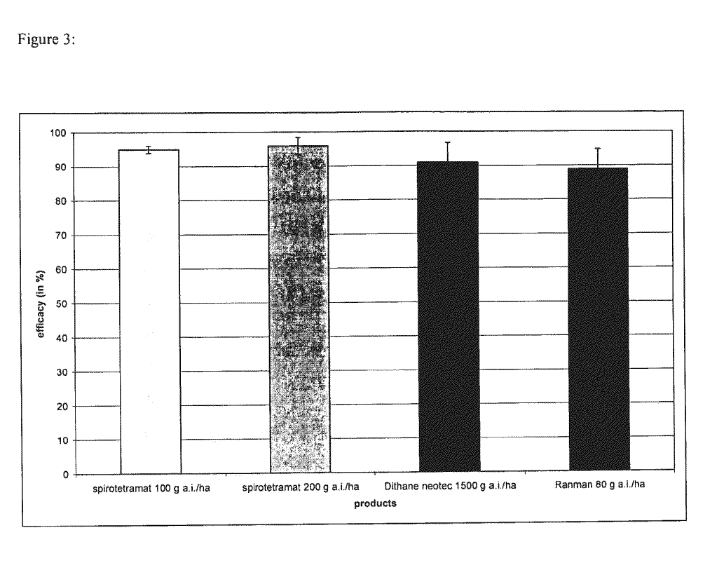

Notation is carried out 6 days after the contamination and consists in evaluating the percentage of foliar surface showing symptoms of sporulation, in comparison with the untreated control but also contamined (UTC) (FIG. 3)

See FIG. 3 for: Efficacy of spirotetramat against P. infestans on tomato in preventive 24 hour conditions.

6 days after the inoculation the untreated controls shows 82% of contamination.

The different references Dithane Neotec® and Ranman® show a very good efficacy against P. infestans tomato late blight with 91% and 89% of efficacy (FIG. 3) when spirotetramat controlled 95% of the disease with a very small standard deviation at 100 and 200 g a.i./ha.

### EXAMPLE 2

### In Vivo Test Against Peronospora parasitica (Crucifer Downy Mildew)

Spirotetramat is prepared by dilution of the SC100 g/l formulation in water to obtain the desired active material concentration.

Cabbage plants (Eminence variety) in starter cups, sown on a 50/50 peat soil-pozzolana substrate and grown at 18-20° C., are treated at the cotyledon stage by spraying with the aqueous suspension described above at 500, 125 and 31 mg/l.

Plants, used as controls, are treated with an aqueous solution not containing the active material.

After 24 hours, the plants are contaminated by spraying them with an aqueous suspension of Peronospora parasitica spores (37 500 spores per ml). The spores are collected from infected plants.

The contaminated cabbage plants are incubated for 5 days at 20° C., under a humid atmosphere.

Grading is carried out 5 days after the contamination, in comparison with the control plants.

Under these conditions, spirotetramat showed 100% activity on Peronospora parasitica at 500, 125 and 31 mg/l of active ingredient.

### EXAMPLE 3

### In Vivo Test Against Plasmopara viticola (Vine Downy Mildew)

The treatment is done by spray application in a spray cabinet at 500 L/ha with the aqueous dilutions of spirotetramat SC100 g/l formulation from 25 to 200 g a.i./ha.

| | | | Dose | Corresponding |
|---|---|---|---|---|
| Active | | | product | dose active |
| Ingredient | Formulation | | tested/ha | g a.i./ha |
| spirotetramat | 100 | g/L SC | | 200-150-100- |
| (Movento ®) | | | | 75-50-25 |
| fluopicolide + | 44.4 + 666.7 | g/kg WG | 3 kg | 133 + 2000 |
| fosetyl- | | | | |
| Al (Profiler ®) | | | | |
| mancozebe | 750 | g/kg WG | 2 kg | 1500 |
| (Dithane | | | | |
| Neotec ®) | | | | |

The treatment is applied on six vine plants (Cabernet sauvignon variety, 9 weeks old) 24 hours and the plants are placed in a climatic chamber at 18° C. before inoculation.

The inoculation consists on spraying the sporangia suspension calibrated at 100 000 sporangia/ml, at the lower leaf face of each plant 24 h after the treatment and the plants are then placed in a climatic chamber at 18° C. day and night with saturate humidity until the symptoms assessment.

Grading is carried out 5 days after the contamination, in comparison with the control plants.

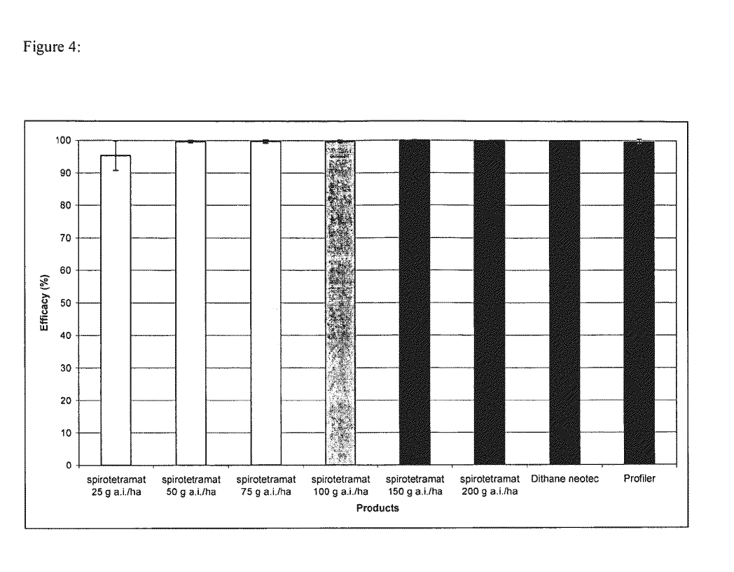

Under these conditions, spirotetramat shows 100% activity against Plasmopara viticola vine downy mildew from 25 to 200 g.a.i./ha (FIG. 4).

See FIG. 4 for: Spirotetramat efficacy against P. viticola vine downy mildew in preventive conditions (24 h).

1. (canceled)

2. The method as claimed in claim 13, where the plant to be treated is grown in an artificial growth substrate.

3. The method as claimed in claim 2, where the artificial growth substrate is selected from the group consisting of rock wool, glass wool, quartz sand, gravel, expanded clay and vermiculite.

4. The method as claimed in claim 13, where the plant to be treated is planted in a closed system.

5. The method as claimed in claim 13, where the plant to be treated is selected from the group consisting of vegetables, and vine.

6. The method as claimed in claim 13, where the plant to be treated is selected from the group consisting of potatoes, tomatoes, and cabbages.

7. The method as claimed in claim 13, where the plant to be treated is selected from the group consisting of vine.

8. The method as claimed in claim 13, for controlling pathogens of fungal and bacterial diseases.

9. The method as claimed in claim 8, for controlling Phytophthora infestans.

10. The method as claimed in claim 8, for controlling Peronospora parasitica.

11. The method as claimed in claim 8, for controlling Plasmopara viticola.

12. A method for controlling pathogens, characterized in that compounds of the formulae (I) and (II) according to claim 13 are allowed to act on the pathogens or their surroundings.

13. A method for controlling pathogens comprising treating a plant or plant part with a compound of formula (I) or (II) [chemical structure]
